(19) United States
(12) Patent Application Publication
(10) Pub. No.: US 2015/0120734 A1
(43) Pub. Date: Apr. 30, 2015

(54) APPARATUS AND METHOD FOR MANAGING DATA CLUSTER

(71) Applicant: SAMSUNG SDS CO., LTD., Seoul (KR)

(72) Inventors: Soon-Hwan KWON, Seoul (KR); Hyung-Chan KIM, Seoul (KR); Kyu-Sam OH, Seoul (KR); Bum-Joon SEO, Seoul (KR)

(73) Assignee: SAMSUNG SDS CO., LTD., Seoul (KR)

(21) Appl. No.: 14/527,924

(22) Filed: Oct. 30, 2014

(30) Foreign Application Priority Data
Oct. 31, 2013 (KR) 10-2013-0131012

(51) Int. Cl. G06F 17/30

(52) U.S. Cl. CPC G06F 17/30946
USPC 707/737

(57) ABSTRACT

Disclosed are an apparatus and method for managing data clusters. The data cluster management apparatus may include: a cluster selection unit configured to calculate a similarity of each of the data clusters with respect to input data, and select, based on the similarity, a data cluster from among the data clusters; and a cluster update unit configured to determine, based on the selected data cluster and the input data, whether the input data is included in the selected data cluster, and use the input data in accordance with the determination to create a new data cluster or update the selected data cluster.

### CROSS-REFERENCE TO RELATED APPLICATION

This application claims priority to and the benefit of Korean Patent Application No. 2013-0131012, filed on Oct. 31, 2013, the disclosure of which is incorporated herein by reference in its entirety.

### BACKGROUND

1. Field The present disclosure relates to an apparatus and method for managing data clusters to adaptively update the data clusters as circumstances change.

2. Discussion of Related Art

Recently, a massively increased amount of data has attracted attention to data management solutions for clustering the data. The term “cluster” means a group of data items having similar characteristics, where the data are grouped according to their several attributes. With the concept of a cluster, there have been developments in diagnostic systems that use a large amount of data.

In such diagnostic systems using a large amount of data, minor changes in input data occur continuously. For example, for a data center, there are continual minor changes such as a software patch, an equipment movement, and a change of season.

According to such minor changes, a cluster-based diagnostic system may need to re-establish a cluster by moving, deleting, creating, or probabilistically adjust the cluster. However, the re-establishment of the cluster according to the minor changes requires significant cost and time. Furthermore, the conventional cluster-based diagnostic system uses a fixed cluster to diagnose data and, therefore, is required to re-create the cluster for every change in the system. Moreover, the diagnostic system using the fixed cluster also has a drawback of low diagnostic accuracy.

### SUMMARY

The present disclosure is directed to an apparatus and method for managing data clusters, which may update a cluster or create a new cluster on the basis of similarities between input data and the clusters.

The present disclosure is also directed to an apparatus and method for managing data clusters, which may calculate similarities on the basis of a representative value of the input data and representative values of the clusters and select a cluster to be updated on the basis of thresholds.

The present disclosure is also directed to an apparatus and method for managing data clusters, which may modify, delete, restore, or create a cluster through a user input.

According to an exemplary embodiment, there is provided an apparatus for managing data clusters, the apparatus including: a cluster selection unit configured to calculate a similarity of each of the data clusters with respect to input data, and select, based on the similarity, a data cluster from among the data clusters; and a cluster update unit configured to determine, based on the selected data cluster and the input data, whether the input data is included in the selected data cluster, and use the input data in accordance with the determination to create a new data cluster or update the selected data cluster.

The similarity may indicate a distance between a representative value of the input data and a representative value of each of the data clusters.

Each of the data clusters may be associated with a threshold, the cluster selection unit may extract, from among the data clusters, data clusters such that the similarity of each of the extracted data clusters is less than the threshold associated therewith, and the cluster selection unit may select, from among the extracted data clusters, the data cluster such that the similarity of the selected data cluster is less than the similarity of any other one of the extracted data clusters.

The cluster update unit may perform the determination based on a representative value of the input data and a representative value of the selected data cluster.

The cluster update unit may use a representative value of the input data and metadata of the input data to create the new data cluster or update the selected data cluster.

When it is determined that the input data is not included in the selected data cluster, the cluster update unit may create the new data cluster and set a threshold of the new data cluster based on the threshold associated with the selected data cluster.

The threshold of the new data cluster may be set to be less than the threshold associated with the selected data cluster.

The apparatus may further include: a cluster storage configured to store the data clusters; and an editing unit configured to receive a user input for modifying, deleting, or restoring the clusters stored in the cluster storage or creating an additional data cluster.

The editing unit may display the stored data clusters based on the threshold associated with each of the stored data clusters.

Each of the stored data clusters may be associated with an identifier indicating a deletion state, and the editing unit may change the identifier of a data cluster selected for deletion or restoration in accordance with the user input.

According to another exemplary embodiment, there is provided a method of managing data clusters, the method including: calculating a similarity of each of the data clusters with respect to input data; selecting, based on the similarity, a data cluster from among the data clusters; determining, based on the selected data cluster and the input data, whether the input data is included in the selected data cluster; and using the input data in accordance with the determination to create a new data cluster or update the selected data cluster.

The similarity may indicate a distance between a representative value of the input data and a representative value of each of the data clusters.

Each of the data clusters may be associated with a threshold, and the selecting of the data cluster may include: extracting, from among the data clusters, data clusters such that the similarity of each of the extracted data clusters is less than the threshold associated therewith; and selecting, from among the extracted data clusters, the data cluster such that the similarity of the selected data cluster is less than the similarity of any other one of the extracted data clusters.

The determination may be performed based on a representative value of the input data and a representative value of the selected data cluster.

The using of the input data may include using a representative value of the input data and metadata of the input data to create the new data cluster or update the selected data cluster.

The using of the input data may include: when it is determined that the input data is not included in the selected data cluster, creating the new data cluster; and setting a threshold of the new data cluster based on the threshold associated with the selected data cluster.

The setting may include setting the threshold of the new data cluster to be less than the threshold of the selected data cluster.

The method may further include receiving a user input for modifying, deleting, or restoring the data clusters or creating an additional data cluster.

The method may further include displaying the data clusters based on the threshold associated with each of the data clusters.

Each of the data clusters may be associated with an identifier indicating a deletion state, and the method may further include changing the identifier of a data cluster selected for deletion or restoration in accordance with the user input.

### BRIEF DESCRIPTION OF THE DRAWINGS

The above and other objects, features, and advantages of the present disclosure will become more apparent to those familiar with this field from the following detailed description when taken in conjunction with the accompanying drawings, in which:

FIG. 1 is a block diagram showing an apparatus for managing data clusters according to an embodiment of the present disclosure;

FIG. 2 is a block diagram showing formats of data clusters in an apparatus for managing data clusters according to an embodiment of the present disclosure;

FIG. 3 is a view for describing an update of a selected cluster according to an embodiment of the present disclosure;

FIG. 4 is a view for describing a process of creating a new cluster and setting a threshold according to an embodiment of the present disclosure;

FIG. 5 is a flowchart showing a method of managing a cluster according to an embodiment of the present disclosure;

FIG. 6 is a flowchart showing a method of modifying a cluster using an editing unit of an apparatus for managing data clusters according to an embodiment of the present disclosure;

FIG. 7 is a flowchart showing a method of deleting a cluster using an editing unit of an apparatus for managing data clusters according to an embodiment of the present disclosure;

FIG. 8 is a flowchart showing a method of restoring a cluster using an editing unit of an apparatus for managing data clusters according to an embodiment of the present disclosure; and

FIG. 9 is a flowchart showing a method of creating a cluster using an editing unit of an apparatus for managing data clusters according to an embodiment of the present disclosure.

### DETAILED DESCRIPTION OF EXEMPLARY EMBODIMENTS

Hereinafter, detailed embodiments of the present disclosure will be described with reference to drawings. The following detailed descriptions are provided to assist the reader in gaining a comprehensive understanding of the method, apparatuses, and/or systems described herein. However, the embodiments are merely examples and are not to be construed as limiting the present disclosure.

Various details already understood by those familiar with this field will be omitted to avoid obscuring the gist of the present disclosure. Terminology described below is defined considering functions in the present disclosure and may vary according to a user's or operator's intention or usual practice. Thus, the meanings of the terminology should be interpreted based on the overall context of the present specification. The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

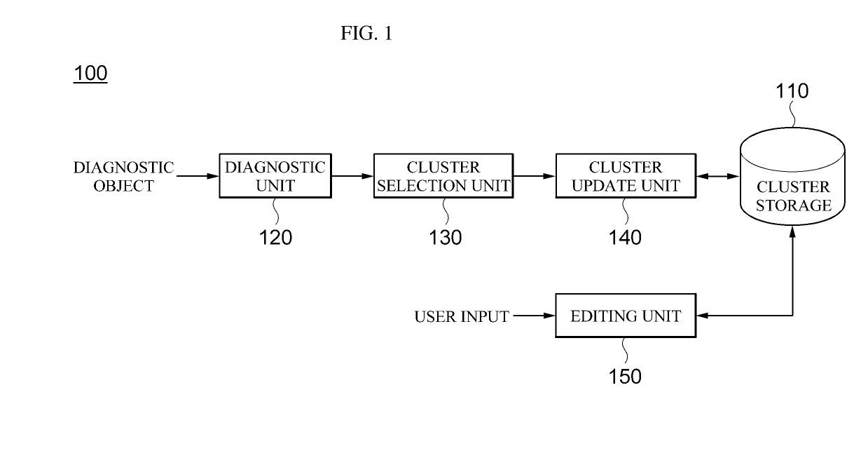

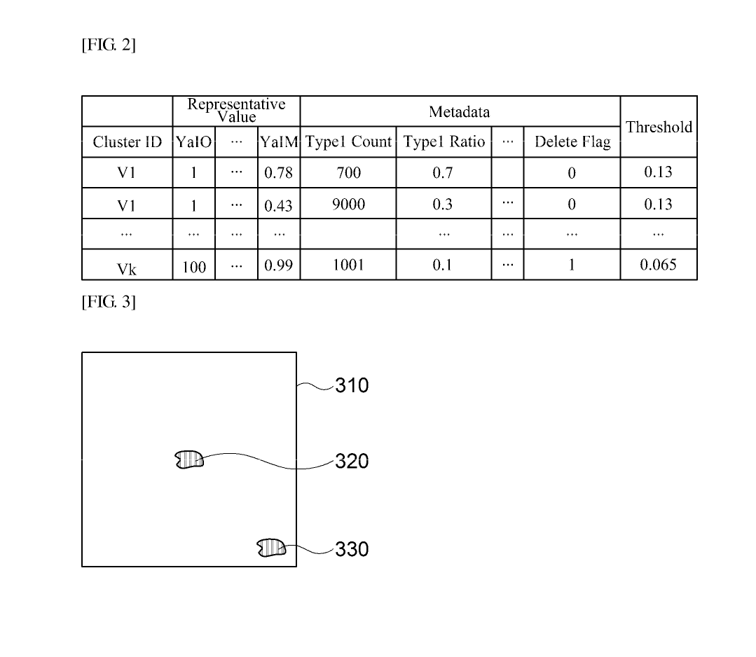

FIG. 1 is a block diagram showing an apparatus for managing data clusters according to an embodiment of the present disclosure, and FIG. 2 is a block diagram showing a format of a data cluster in an apparatus for managing data clusters according to an embodiment of the present disclosure.

The term “data cluster” used in the following descriptions of embodiments of the present disclosure means a group of data items having similar characteristics, where the data are grouped according to their several attributes. Hereinafter, a data cluster may be referred to as a cluster.

As shown in FIG. 1, a data cluster management apparatus 100 may include a cluster storage 110, a diagnostic unit 120, a cluster selection unit 130, a cluster update unit 140, an editing unit 150.

The cluster storage 110 has stored therein a plurality of clusters having a cluster format as shown in FIG. 2. The cluster format may represent cluster IDs, representative values, metadata, and thresholds. In a certain embodiment, a plurality of representative values, metadata, and a threshold are set for each cluster ID. Further, the metadata of a cluster may include statistical data, a cluster ID of a selected cluster (i.e., one that is closest to the cluster) which is referenced when the particular cluster is created, a creation date of the cluster, a modification date of the cluster, a delete flag, a count, a ratio, and the like.

The threshold of a cluster is used for a comparison with a similarity of the cluster with respect to a diagnosis target (hereinafter, referred to as an “input data”) which is externally input. In addition, the delete flag of a cluster is an identifier indicating a deletion state of the cluster. Specifically, when the delete flag is a value of “1,” this may indicate that the cluster is deleted.

The diagnostic unit 120 may receive input data having a representative value and metadata, and perform a diagnosis by comparing the input data with a cluster stored in the cluster storage 110. Furthermore, the diagnostic unit 120 may provide the input data to the cluster selection unit 130.

In an embodiment of the present disclosure, the input data may be real-time data that is generated from a data center or a building.

The cluster selection unit 130 may use the input data and the clusters stored in the cluster storage 110 to calculate a similarity of each of the clusters with respect to the input data. In a certain embodiment, the cluster selection unit 130 may compute a distance between a representative value of the input data and a representative value of each of the clusters stored in the cluster storage 110 to calculate the similarity.

The distance may be computed through “Euclidean distance,” “Manhattan distance” or the like, but is not limited thereto.

When both of the representative value of the input data and the representative value of a selected cluster are points in a two dimensional space, the distance may be calculated according to the following expression:

Distance value (Similarity)=√(Val0−Val0′)²+(Val1−Val1′)² [Equation 1]

where (Val0, Val1) is the representative value of the input data, and (Val0′, Val1′) is the representative value of the selected cluster.

In addition, the cluster selection unit 130 may select a cluster from among the clusters on the basis of the similarities of the clusters. In a certain embodiment, the cluster selection unit 130 may extract, from among the clusters, clusters such that the similarity of each of the extracted clusters is less than the threshold associated therewith, and select, from among the extracted clusters, the cluster such that the similarity of the selected cluster is a minimum one of those of the other extracted clusters.

The cluster update unit 140 may determine, on the basis of the selected cluster and the input data, whether the input data is included in the selected cluster. In a certain embodiment, the cluster update unit 140 may determine, based on whether the representative value of the input data corresponds to the selected cluster, whether the input data is included in the selected cluster.

In accordance with a result of the determination, the cluster update unit 140 may create a new cluster in the cluster storage 110 or update the selected cluster in the cluster storage 110. Specifically, the cluster update unit 140 may use a representative value and metadata of the input data to update the selected cluster or to create a new cluster in the cluster storage 110.

In this case, a threshold of the new cluster may be set to be less than the threshold of the selected value.

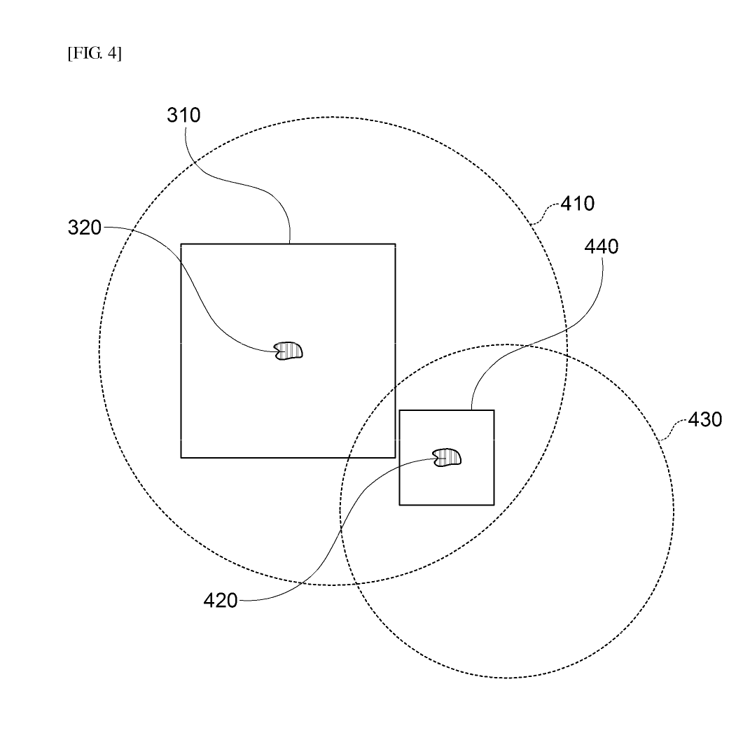

With reference to FIGS. 3 and 4, the following illustration provides an example in which the cluster selection unit 130 and the cluster update unit 140 are applied.

FIG. 3 is a view for describing an update of a selected cluster according to an embodiment of the present disclosure, and FIG. 4 is a view for describing a process of creating a new cluster and setting a threshold according to an embodiment of the present disclosure.

First, as shown in FIG. 3, a selected cluster has a range 310, which indicates internal data of the selected cluster, and a representative value 320 of the selected cluster. When a representative value 330 of input data is included in the range 310 of the selected cluster (i.e., when the representative value 330 of the input data may be included in the internal data of the selected cluster), the cluster update unit 140 may perform an update of the selected cluster using the input data. Here, the input data may have the representative value 330 and metadata.

For example, the representative value 320 of the selected cluster is moved to a new “center of mass” which is determined in consideration of the representative value 330 of the input data, the representative value 320 of the selected cluster, and the count number of values that constitute the cluster. When the diagnostic result of the diagnostic unit 120 indicates that the input data is classified into a first type of data of the selected cluster, a count of the first type is increased by 1, and a ratio of the first type is modified. In other words, the representative value 320 and metadata of the selected cluster may be updated using the representative value 330 and metadata of the input data.

When the input data corresponds to a new cluster (for example, as shown in FIG. 4, when the representative value 420 of the input data is included in a range of the threshold 410 set for the selected cluster 310, but is not included in the selected cluster 310), the cluster update unit 140 may set, as a threshold 430 for a new cluster 440, a value that is less than the threshold 410 of the selected cluster 310, and create the new cluster 440 using the representative value 420 and metadata of the input data.

The setting of the threshold will be illustrated as follows.

For example, when the selected cluster corresponds to a cluster ID “U1” and the threshold of the selected cluster is 1.3, a threshold of input data that is not included in the range of the selected cluster may be a value obtained by multiplying a value of A (0<A<1) and the threshold of the selected cluster. Accordingly, the new cluster 440 having a threshold less than the threshold of the selected cluster may be created as shown in FIG. 4. Here, when A is 0.5, the threshold of the new cluster 440 may be 0.65.

As described above, the threshold of the new cluster is set to be less than the threshold of the selected cluster, and this is because the new cluster is a less reliable cluster, i.e., a cluster which is created according to the diagnostic result, other than a cluster that is directly selected by an operator or is created after being determined to be reliable.

A method of setting a threshold may include a k-fold cross validation method, but is not limited thereto. The k-fold cross validation method involves dividing data constituting a cluster into k equal size pieces and configuring a single data piece as a test set and the remaining k-1 data pieces as a learning set. To obtain a threshold suitable for the input data, clustering is performed using the learning set and then adaptive clustering is applied to the test set. Such a cross-validation process is then repeated k times, with each of the k pieces used exactly once. The k results may be averaged to create a new cluster.

The editing unit 150 may provide an interface that receives a user input for modifying, deleting or restoring a cluster stored in the cluster storage 110 or creating a cluster.

When the user input is received, the editing unit 150 may check the user input to determine whether the cluster is editable, and if the editing is impossible, may inform a user that the editing is not allowed. For example, the editing unit 150 may determine whether the user input corresponds to a cluster format to determine whether the editing is allowed, and if the edit is impossible, may generate a predetermined edit disallowance message to display the message on a display device (not shown).

In addition, when the user input is for creation or restoration of a cluster, the editing unit 150 may check, on the basis of the clusters stored in the cluster storage 110, redundancy of the cluster to be created or restored and determine, in accordance with the check result, whether to create or restore the cluster. Here, when the cluster to be created or restored is redundant, the editing unit 150 may generate a disallowance message and display the message on a display device (not shown).

The editing unit 150 may display clusters stored in the cluster storage 110 on the basis of thresholds. Here, the number of clusters to be displayed may be set by a user selection or a user input of conditions.

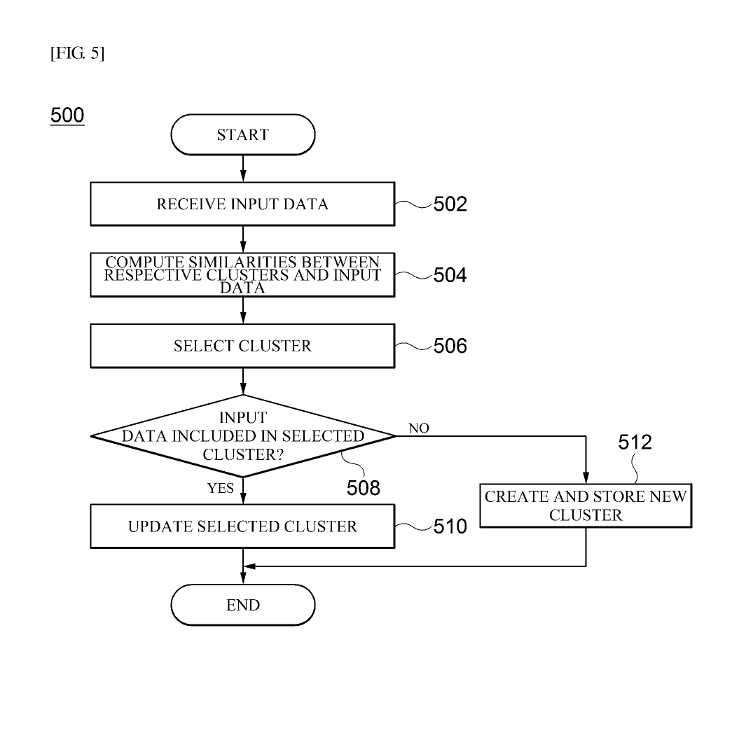

With reference to FIG. 5, the following description illustrates an operational process of the data cluster management apparatus 100.

FIG. 5 is a flowchart showing a cluster management method 500 according to an embodiment of the present disclosure.

The method as shown in FIG. 5 may be performed by the diagnostic unit 120, the cluster selection unit 130, and the cluster update unit 140 of the above-described data cluster management apparatus 100. In the flowchart of FIG. 5, the method is illustrated as having a plurality of operations. At least some of the operations may be performed in a different order, performed in combination with another one of the operations, omitted, performed in sub-operations, or performed in addition to one or more operations that are not shown. Furthermore, according to an embodiment, one or more operations that are not shown in FIG. 5 may be performed together with the method shown in FIG. 5.

As shown in FIG. 5, when input data is received by the diagnostic unit 120 in operation 502, the cluster selection unit 130 computes similarities between the input data and respective clusters stored in the cluster storage 110 (operation 504). Specifically, the similarity of each of the clusters with respect to the input data may be calculated by computing a distance between a representative value of the input data and a representative value of the cluster.

Next, the cluster selection unit 130 selects a cluster from the cluster storage 110 by comparing each similarity with a threshold that is set for the respective cluster (operation 506). Specifically, the cluster selection unit 130 may extract, from among the clusters, clusters each of which has its similarities less than its threshold, and select, from the extracted clusters, a cluster having the smallest similarity.

Subsequently, the cluster update unit 140 may determine, based on the selected cluster and the input data, whether the input data is included in the selected cluster (operation 508). Specifically, the cluster update unit 140 may determine whether the input data is included in the selected cluster on the basis of whether the representative value of the input data may fall within the selected cluster.

When it is determined in operation 508 that the input data is included in the selected cluster, the cluster update unit 140 uses the input data to update the selected cluster (operation 510). Specifically, the cluster update unit 140 may update the selected cluster using the representative value and the metadata of the input data.

When it is determined in operation 508 that the input data is not included in the selected cluster, the cluster update unit 140 creates a new cluster on the basis of the input data and stores the new cluster in the cluster storage 110 (operation 512). Specifically, the cluster update unit 140 may set a threshold of the new cluster on the basis of a threshold of the selected cluster and create the new cluster in consideration of the threshold and the representative value and metadata of the input data.

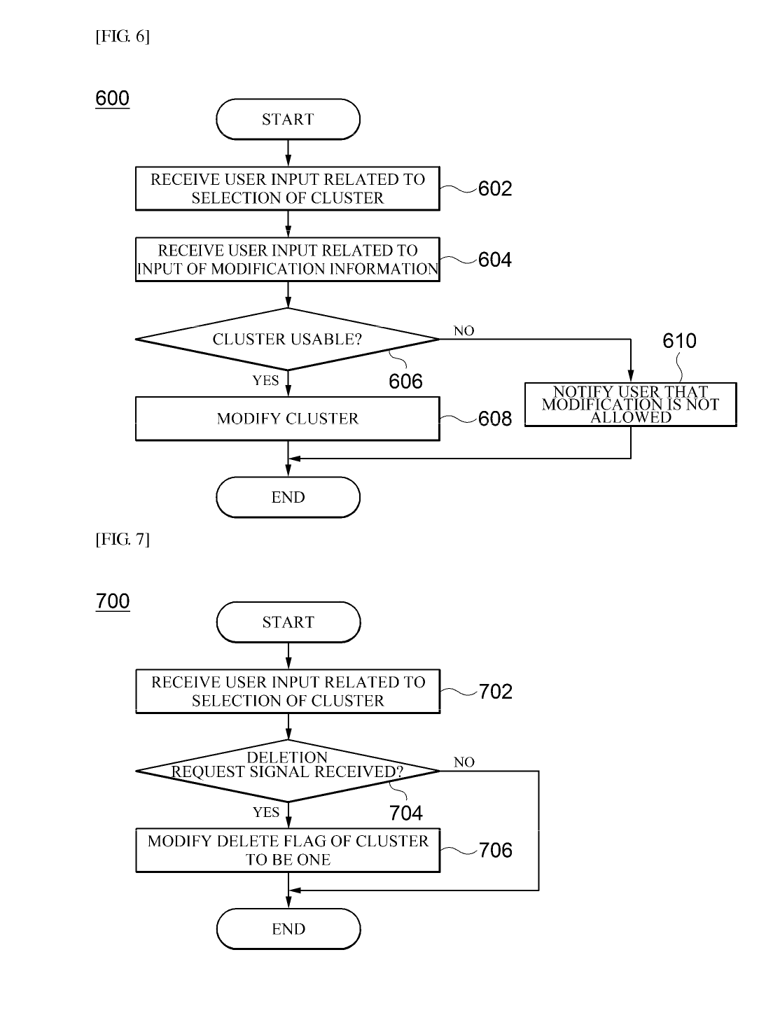

With reference to FIGS. 6 to 9, the following description illustrates a method by which the editing unit 150 of the data cluster management apparatus 100 manages clusters stored in the cluster storage 110.

FIG. 6 is a flowchart showing a method 600 of modifying a cluster using the editing unit 150 of the data cluster management apparatus 100 according to an embodiment of the present disclosure.

As shown in FIG. 6, the editing unit 150 receives a user input for modifying a cluster, i.e., an input related to a selection of a cluster to be modified (operation 602). Thus, the editing unit 150 may select a cluster corresponding to the user input from the cluster storage 110.

Subsequently, the editing unit 150 receives a user input for performing a modification, i.e., modification-related information (operation 604).

Next, with a logic check for the modification-related information, the editing unit 150 determines whether the cluster is usable (operation 606).

When it is determined in operation 606 that the cluster is usable, the editing unit 150 modifies the selected cluster using the modification-related information (operation 608), or otherwise, the editing unit 150 notifies a user that the modification is not allowed (operation 610). Specifically, the editing unit 150 may generate and display a modification disallowance message for the notification to the user.

FIG. 7 is a flowchart showing a method 700 of deleting a cluster using the editing unit 150 of the data cluster management apparatus 100 according to an embodiment of the present disclosure.

As shown in FIG. 7, the editing unit 150 receives an input of a user who attempts to delete a cluster, i.e., an input related to selection of a cluster to be deleted (operation 702).

Subsequently, the editing unit 150 determines whether a deletion request signal, for example, a user manipulation of a deletion request, is received (operation 704).

When it is determined in operation 704 that the deletion request signal is received, the editing unit 150 modifies a delete flag of the cluster selected in operation 702 to be “1” (operation 706).

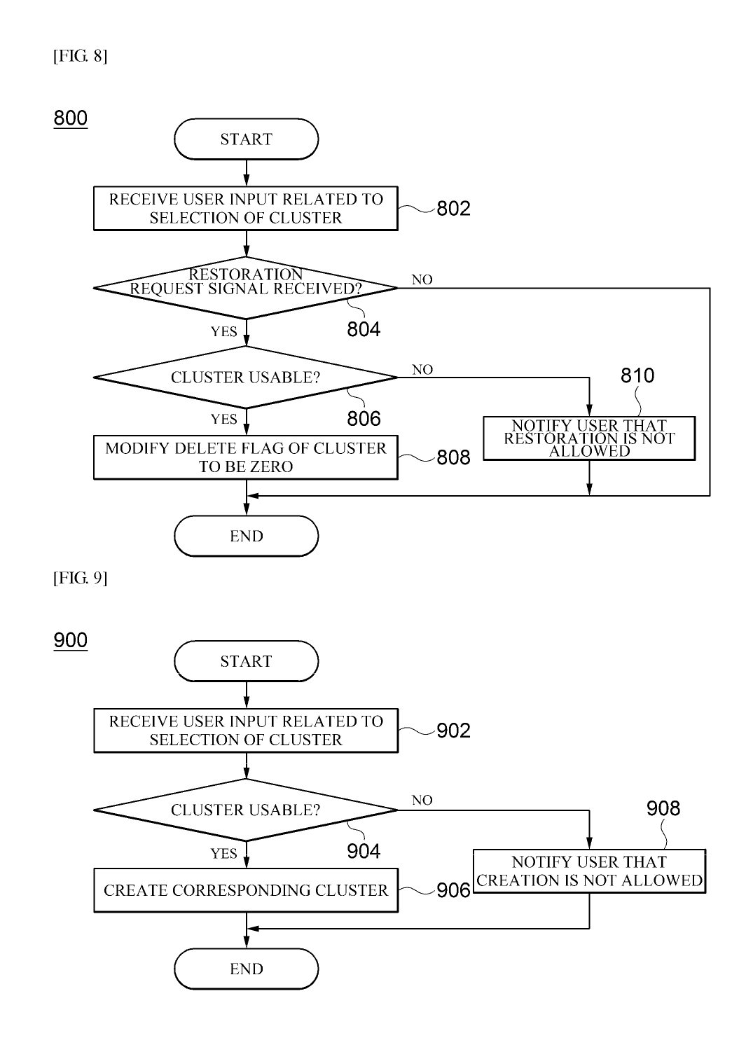

FIG. 8 is a flowchart showing a method 800 of restoring a cluster using the editing unit 150 of the data cluster management apparatus 100 according to an embodiment of the present disclosure.

As shown in FIG. 8, the editing unit 150 receives an input of a user who attempts to restore a cluster, i.e., an input related to selection of a cluster to be restored (operation 802).

Subsequently, the editing unit 150 determines whether a restoration request signal, for example, a user manipulation of a restoration request, is received (operation 804).

When it is determined in operation 804 that the restoration request signal is received, the editing unit 150 determines whether the cluster to be restored, i.e., the selected cluster, is usable by using a logic check for redundancy of the cluster.

When it is determined in operation 806 that the selected cluster is usable, the editing unit 150 modifies a delete flag of the cluster selected in operation 802 to be “0” (operation 808).

When it is determined in operation 806 that the selected cluster is not usable, the editing unit 150 notifies a user that the restoration is not allowed (operation 810). Specifically, the editing unit 150 may generate and display a restoration disallowance message for the notification to the user.

FIG. 9 is a flowchart showing a method 900 of creating a cluster using an editing unit 150 of the data cluster management apparatus 100 according to an embodiment of the present disclosure.

As shown in FIG. 9, the editing unit 150 receives an input of a user who attempts to create a cluster, i.e., an input related to a cluster to be newly created (operation 902).

Subsequently, the editing unit 150 determines whether the cluster to be created is usable by using a logic check for redundancy of the selected cluster (operation 904).

When it is determined in operation 904 that the selected cluster is usable, the editing unit 150 creates a cluster in the cluster storage 110 on the basis of the user input (operation 906).

When it is determined in operation 904 that the selected cluster is not usable, the editing unit 150 notifies a user that the creation is not allowed (operation 908). Specifically, the editing unit 150 may generate and display a creation disallowance message for the notification to the user.

Meanwhile, an exemplary embodiment of the present disclosure can include a computer-readable storage medium including a program for performing the methods described herein, e.g., the method 500 for managing clusters based on input data, and the cluster modification, deletion, creation, and restoration methods 600, 700, 800, and 900 using the editing unit 150, on a computer. The computer-readable storage medium may separately include program commands, local data files, local data structures, etc. or include a combination of them. The computer-readable storage medium may be specially designed and configured for the present disclosure, or known and available to those of ordinary skill in the field of computer software. Examples of the computer-readable storage medium include magnetic media, such as a hard disk, a floppy disk, and a magnetic tape, optical recording media, such as a CD-ROM and a DVD, magneto-optical media, such as a floptical disk, and hardware devices, such as a ROM, a RAM, and a flash memory, specially configured to store and execute program commands. Examples of the program commands may include high-level language codes executable by a computer using an interpreter, etc., as well as machine language codes made by compilers.

Embodiments of the present disclosure provide an apparatus and a method for managing data clusters to reflect thereupon a variety of change by updating a cluster or creating a new cluster on the basis of similarities of respective clusters with respect to input data.

Further, an apparatus and a method for managing data clusters according to embodiments of the present disclosure may determine, on the basis of similarities and thresholds, whether a new diagnosis target (i.e., input data) results from minor changes such as a software patch, an equipment movement, and a change of season, and use the determination result to update a cluster or create a new cluster. Accordingly, applying the apparatus and method to a diagnostic system may facilitate an implementation of the system upon which the minor changes are adaptively reflected.

According to embodiments of the present disclosure, a cluster may be automatically created and updated on the basis of input data, and the cost for the cluster management may be reduced.

It will be apparent to those familiar with this field that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

What is claimed is:

1. An apparatus for managing data clusters, the apparatus comprising:
a cluster selection unit configured to calculate a similarity of each of the data clusters with respect to input data, and select, based on the similarity, a data cluster from among the data clusters; and
a cluster update unit configured to determine, based on the selected data cluster and the input data, whether the input data is included in the selected data cluster, and use the input data in accordance with the determination to create a new data cluster or update the selected data cluster.

2. The apparatus of claim 1, wherein the similarity indicates a distance between a representative value of the input data and a representative value of each of the data clusters.

3. The apparatus of claim 1, wherein each of the data clusters is associated with a threshold, wherein the cluster selection unit extracts, from among the data clusters, data clusters such that the similarity of each of the extracted data clusters is less than the threshold associated therewith, and wherein the cluster selection unit selects, from among the extracted data clusters, the data cluster such that the similarity of the selected data cluster is less than the similarity of any other one of the extracted data clusters.

4. The apparatus of claim 1, wherein the cluster update unit performs the determination based on a representative value of the input data and a representative value of the selected data cluster.

5. The apparatus of claim 1, wherein the cluster update unit uses a representative value of the input data and metadata of the input data to create the new data cluster or update the selected data cluster.

6. The apparatus of claim 5, wherein when it is determined that the input data is not included in the selected data cluster, the cluster update unit creates the new data cluster and sets a threshold of the new data cluster based on the threshold associated with the selected data cluster.

7. The apparatus of claim 6, wherein the threshold of the new data cluster is set to be less than the threshold associated with the selected data cluster.

8. The apparatus of claim 1, further comprising:
a cluster storage configured to store the data clusters; and
an editing unit configured to receive a user input for modifying, deleting, or restoring the clusters stored in the cluster storage or creating an additional data cluster.

9. The apparatus of claim 8, wherein the editing unit displays the stored data clusters based on the threshold associated with each of the stored data clusters.

10. The apparatus of claim 8, wherein each of the stored data clusters is associated with an identifier indicating a deletion state, and wherein the editing unit changes the identifier of a data cluster selected for deletion or restoration in accordance with the user input.

11. A method of managing data clusters, the method comprising:
calculating a similarity of each of the data clusters with respect to input data;
selecting, based on the similarity, a data cluster from among the data clusters;
determining, based on the selected data cluster and the input data, whether the input data is included in the selected data cluster; and
using the input data in accordance with the determination to create a new data cluster or update the selected data cluster.

12. The method of claim 11, wherein the similarity indicates a distance between a representative value of the input data and a representative value of each of the data clusters.

13. The method of claim 11, wherein each of the data clusters is associated with a threshold, and wherein the selecting of the data cluster comprises:
extracting, from among the data clusters, data clusters such that the similarity of each of the extracted data clusters is less than the threshold associated therewith; and
selecting, from among the extracted data clusters, the data cluster such that the similarity of the selected data cluster is less than the similarity of any other one of the extracted data clusters.

14. The method of claim 11, wherein the determination is performed based on a representative value of the input data and a representative value of the selected data cluster.

15. The method of claim 11, wherein the using of the input data comprises using a representative value of the input data and metadata of the input data to create the new data cluster or update the selected data cluster.

16. The method of claim 11, wherein the using of the input data comprises:
when it is determined that the input data is not included in the selected data cluster, creating the new data cluster; and
setting a threshold of the new data cluster based on the threshold associated with the selected data cluster.

17. The method of claim 16, wherein the setting comprises setting the threshold of the new data cluster to be less than the threshold of the selected data cluster.

18. The method of claim 11, further comprising:
receiving a user input for modifying, deleting, or restoring the data clusters or creating an additional data cluster.

19. The method of claim 18, further comprising:
displaying the data clusters based on the threshold associated with each of the data clusters.

20. The method of claim 18, wherein each of the data clusters is associated with an identifier indicating a deletion state, and wherein the method further comprises changing the identifier of a data cluster selected for deletion or restoration in accordance with the user input.
